(19) United States
(12) Patent Application Publication
(10) Pub. No.: US 2015/0370672 A1
(43) Pub. Date: Dec. 24, 2015

(54) TRIGGER DETECTION FOR POST CONFIGURATION TESTING OF PROGRAMMABLE LOGIC DEVICES

(71) Applicant: Lattice Semiconductor Corporation, Hillsboro, OR (US)

(72) Inventors: Pradeep Lenka, Milpitas, CA (US); Andrew Lin, San Jose, CA (US); Brian Caslis, Wilsonville, OR (US)

(21) Appl. No.: 14/313,443

(22) Filed: Jun. 24, 2014

(51) Int. Cl. G06F 11/26

(52) U.S. Cl. CPC G06F 11/26

(57) ABSTRACT

Various techniques are provided to determine signal values of a programmable logic device (PLD) prior to the running of an external test application. In one example, a machine-implemented method includes monitoring, by a PLD, a signal of the PLD. The method also includes detecting a trigger condition associated with the signal. The method also includes storing data in memory of the PLD corresponding to values of the signal. The method also includes passing the stored data from the PLD to an external device running a test application. The stored data comprises values of the signal occurring before the running of the test application.

### TECHNICAL FIELD

The present invention relates generally to programmable logic devices and, more particularly, to the testing of user designs implemented in such devices.

### BACKGROUND

Programmable logic devices (PLDs) (e.g., field programmable gate arrays (FPGAs), complex programmable logic devices (CPLDs), field programmable system on a chips (FPSCs), or other types of programmable devices) may be configured with various user designs to implement desired functionality. Typically, the user designs are synthesized and mapped into configurable resources (e.g., programmable logic gates, look-up tables (LUTs), embedded hardware, or other resources) and interconnections available in particular PLDs. Physical placement and routing for the synthesized and mapped user designs are then determined to generate configuration data for the particular PLDs.

After being programmed with the configuration data, the PLD may be tested, for example, by an application running on an external system that interfaces with the PLD. Such a test application will typically monitor signals of the PLD which are passed from the PLD to the external system. The test application may log the signal data, for example, if various predetermined conditions occur (e.g., if a monitored signal exhibits a particular value).

However, there is typically a delay between the time the PLD starts running in accordance with configured logic (e.g., after the PLD is powered on and configured for operation) and when the test application starts and begins logging data. As a result, errors or undesired operations of the PLD that occur before the test application starts cannot be effectively tracked or measured. For example, if the test application detects an unexpected value of one or more signals, the test application may be unable to determine what signal values, states, or other factors preceded the detected error (e.g., prior to the test application startup time). As a result, it can be difficult to properly evaluate PLD performance that occurs shortly after PLD startup.

### BRIEF DESCRIPTION OF THE DRAWINGS

FIG. 1 illustrates a block diagram of a programmable logic device (PLD) in accordance with an embodiment of the disclosure.

FIG. 2 illustrates a design process for a PLD in accordance with an embodiment of the disclosure.

FIG. 3 illustrates a test process for a PLD in accordance with an embodiment of the disclosure.

FIG. 4 illustrates a timeline corresponding to various operations of FIG. 3 in accordance with an embodiment of the disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

In accordance with embodiments set forth herein, techniques are provided to detect and store (e.g., log) signal data (e.g., also referred to as trace data) within a PLD in response to various triggers occurring after the PLD is configured for use. Such data is stored within memory of the PLD itself before an external test application (e.g., on an external system) is operational. When operational, the external test application polls the PLD to receive the data stored by the PLD. The logged data may be reviewed by the test application and/or a user to determine operational conditions of the PLD occurring prior to the startup of the external test application. As a result, possible errors and/or defects in the PLD configuration may be evaluated, despite a lag time between the PLD and test application startup times.

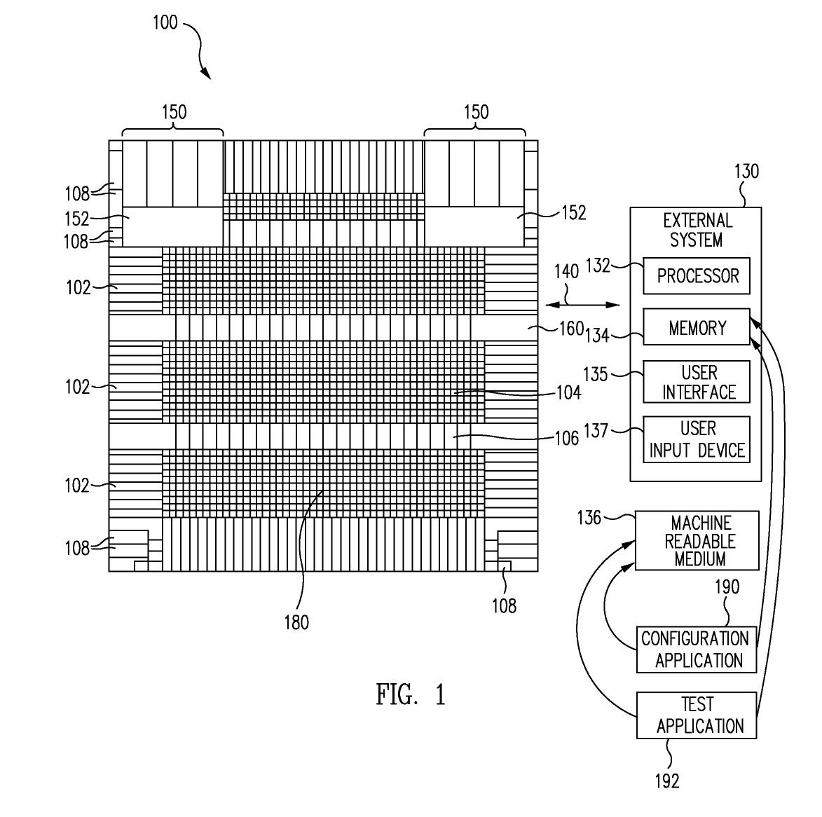

Referring now to the drawings, FIG. 1 illustrates a block diagram of a PLD 100 in accordance with an embodiment of the disclosure. PLD 100 (e.g., a field programmable gate array (FPGA)), a complex programmable logic device (CPLD), a field programmable system on a chip (FPSC), or other type of programmable device) generally includes input/output (I/O) blocks 102 and logic blocks 104 (e.g., also referred to as programmable logic blocks (PLBs), programmable functional units (PFUs), or programmable logic cells (PLCs)).

I/O blocks 102 provide I/O functionality (e.g., to support one or more I/O and/or memory interface standards) for PLD 100, while programmable logic blocks 104 provide logic functionality (e.g., LUT-based logic or logic gate array-based logic) for PLD 100. Additional I/O functionality may be provided by serializer/deserializer (SERDES) blocks 150 and physical coding sublayer (PCS) blocks 152. PLD 100 may also include hard intellectual property core (IP) blocks 160 to provide additional functionality (e.g., substantially predetermined functionality provided in hardware which may be configured with less programming than logic blocks 104).

PLD 100 may also include blocks of memory 106 (e.g., blocks of EEPROM, block SRAM, and/or flash memory), clock-related circuitry 108 (e.g., clock sources, PLL circuits, and/or DLL circuits), and/or various routing resources 180 (e.g., interconnect and appropriate switching logic to provide paths for routing signals throughout PLD 100, such as for clock signals, data signals, or others) as appropriate. In general, the various elements of PLD 100 may be used to perform their intended functions for desired applications, as would be understood by one skilled in the art.

For example, I/O blocks 102 may be used for programming PLD 100, such as memory 106 or transferring information (e.g., various types of data and/or control signals) to/from PLD 100 through various external ports as would be understood by one skilled in the art. I/O blocks 102 may provide a first programming port (which may represent a central processing unit (CPU) port, a peripheral data port, an SPI interface, and/or a sysCONFIG programming port) and/or a second programming port such as a joint test action group (JTAG) port (e.g., by employing standards such as Institute of Electrical and Electronics Engineers (IEEE) 1149.1 or 1532 standards). I/O blocks 102 typically, for example, may be included to receive configuration data and commands (e.g., over one or more connections 140) to configure PLD 100 for its intended use and to support serial or parallel device configuration and information transfer with SERDES blocks 150, PCS blocks 152, hard IP blocks 160, and/or logic blocks 104 as appropriate.

It should be understood that the number and placement of the various elements are not limiting and may depend upon the desired application. For example, various elements may not be required for a desired application or design specification (e.g., for the type of programmable device selected).

Furthermore, it should be understood that the elements are illustrated in block form for clarity and that various elements would typically be distributed throughout PLD 100, such as in and between logic blocks 104, hard IP blocks 160, and routing resources 180 to perform their conventional functions (e.g., storing configuration data that configures PLD 100 or providing interconnect structure within PLD 100). It should also be understood that the various embodiments disclosed herein are not limited to programmable logic devices, such as PLD 100, and may be applied to various other types of programmable devices, as would be understood by one skilled in the art.

An external system 130 (e.g., also referred to as an external device) may be used to create a desired user configuration or design of PLD 100 and generate corresponding configuration data to program (e.g., configure) PLD 100. For example, system 130 may provide such configuration data to one or more I/O blocks 102, SERDES blocks 150, and/or other portions of PLD 100. As a result, programmable logic blocks 104, routing resources 180, and any other appropriate components of PLD 100 may be configured to operate in accordance with user-specified applications.

In the illustrated embodiment, system 130 is implemented as a computer system. In this regard, system 130 includes, for example, one or more processors 132 which may be configured to execute instructions, such as software instructions, provided in one or more memories 134 and/or stored in non-transitory form in one or more non-transitory machine-readable mediums 136 (e.g., a memory or other appropriate storage medium internal or external to system 130). For example, in some embodiments, system 130 may run a PLD configuration application 190, such as Lattice Diamond System Planner software available from Lattice Semiconductor Corporation to permit a user to create a desired configuration and generate corresponding configuration data to program PLD 100. In some embodiments, system 130 may run a test application 192 (e.g., also referred to as a debugging application), such as Lattice Reveal software available from Lattice Semiconductor Corporation to evaluate the operation of PLD 100 after it has been configured.

System 130 also includes, for example, a user interface 135 (e.g., a screen or display) to display information to a user, and one or more user input devices 137 (e.g., a keyboard, mouse, trackball, touchscreen, and/or other device) to receive user commands or design entry to prepare a desired configuration of PLD 100 and/or to identify various triggers used to evaluate the operation of PLD 100, as further described herein.

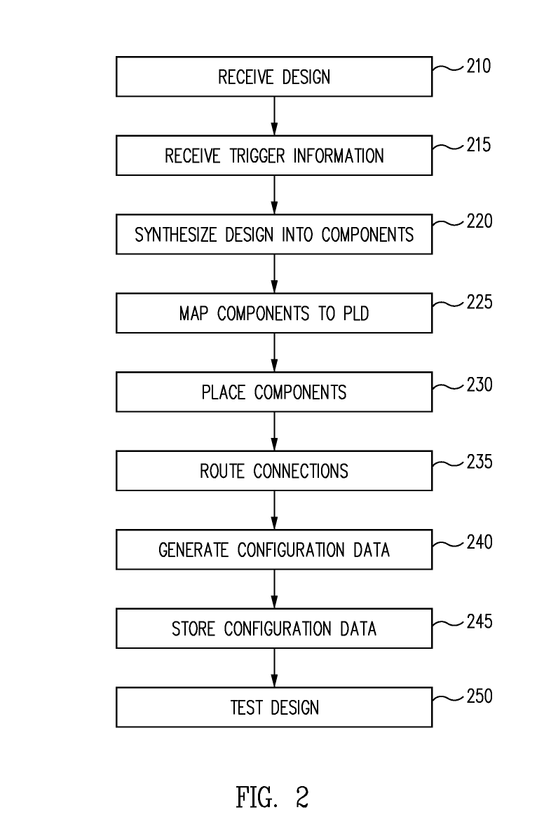

FIG. 2 illustrates a design process for a PLD in accordance with an embodiment of the disclosure. For example, the process of FIG. 2 may be performed by system 130 running configuration application 190 and/or test application 192. In some embodiments, the various files and information referenced in FIG. 2 may be stored, for example, in one or more databases and/or other data structures in memory 134, machine-readable medium 136, and/or otherwise.

In operation 210, system 130 receives a user design that specifies the desired functionality of PLD 100. For example, the user may interact with system 130 (e.g., through user input device 137 and hardware description language (HDL) code representing the design) to identify various features of the design (e.g., high level logic operations, hardware configurations, and/or other features). In some embodiments, the design may be provided in a register transfer level (RTL) description (e.g., a gate level description). System 130 may perform one or more rule checks to confirm that the design describes a valid configuration of PLD 100. For example, system 130 may reject invalid configurations and/or request the user to provide new design information as appropriate.

In operation 215, system 130 receives trigger information (e.g., provided by a user or otherwise) identifying one or more conditions (e.g., triggers) that may occur within PLD 100 during operation. For example, such trigger information may identify values of one or more signals (e.g., associated with state machines, logic, data, or other aspects of PLD 100) which are used as criteria to store signal data.

In one embodiment, a particular state of a state machine running within configured logic of PLD 100 may be identified as a trigger condition. Accordingly, if PLD 100 detects that the state machine transitions to the particular identified state, this detection may be used to trigger the PLD 100 to store the occurrence of the identified state in memory 106 of PLD 100 itself for subsequent use by test application 192. Triggers using counter values or other types of signals and data are also contemplated.

Some of the triggers identified in operation 215 may be implemented in PLD 100 itself (e.g., added to the design implemented in PLD 100). That is, in addition to the user design, configuration data for the PLD 100 (e.g., generated in subsequent operation 240) may further configure logic blocks 104 and/or other appropriate portions of PLD 100 to monitor the identified trigger signals and store (e.g., in memory 106 operating as one or more data buffers) logged data associated with the signals. Accordingly, it will be appreciated that such triggers do not rely on the operation of external test application 192. Rather, such trigger monitoring and data logging may be performed internal to PLD 100 as part of the configured operation of PLD 100 determined by configuration data.

In addition, some of the triggers identified in operation 215 may be implemented as part of test application 192. In this regard, test application 192 may be configured to monitor various signals of PLD 100 in a similar manner as the triggers implemented in PLD 100 previously discussed. However, in contrast to the triggers implemented by PLD 100, the triggers implemented by test application 192 rely on signals being passed from PLD 100 (e.g., from a JTAG port of PLD 100) to external system 130 over one or more connections 140.

In operation 220, system 130 synthesizes the design (e.g., including the design identified in operation 210 and PLD-based triggers identified in operation 215) to create a netlist (e.g., a synthesized RTL description) identifying an abstract logic implementation of the design as a plurality of logic components (e.g., also referred to as netlist components). In some embodiments, the netlist may be stored in Electronic Design Interchange Format (EDIF) in a Native Generic Database (NGD) file.

In some embodiments, synthesizing the design into a netlist in operation 220 may involve converting (e.g., translating) the high-level description of logic operations, hardware configurations, and/or other features in the user design into a set of PLD components (e.g., logic blocks 104 and other components of PLD 100 configured for logic, arithmetic, or other hardware functions to implement the design) and their associated interconnections or signals. Depending on embodiments, the converted design may be represented as a netlist.

In operation 225, system 130 performs a mapping process that identifies components of PLD 100 that may be used to implement the design. In this regard, system 130 may map the netlist to various types of components provided by PLD 100 (e.g., logic blocks 104, embedded hardware, and/or other portions of PLD 100) and their associated signals (e.g., in a logical fashion, but without yet specifying placement or routing). In some embodiments, the mapping may be performed on one or more previously-stored NGD files, with the mapping results stored as a physical design file (e.g., also referred to as an NCD file). In some embodiments, the mapping process may be performed as part of the synthesis process in operation 220 to produce a netlist that is mapped to PLD components.

In operation 230, system 130 performs a placement process to assign the mapped netlist components to particular physical components residing at specific physical locations of the PLD 100 (e.g., assigned to particular logic blocks 104 and/or other physical components of PLD 100), and thus determine a layout for the PLD 100. In some embodiments, the placement may be performed on one or more previously-stored NCD files, with the placement results stored as another physical design file.

In operation 235, system 130 performs a routing process to route connections (e.g., using routing resources 180) among the components of PLD 100 based on the placement layout determined in operation 230 to realize the physical interconnections among the placed components. In some embodiments, the routing may be performed on one or more previously-stored NCD files, with the routing results stored as another physical design file.

Thus, following operation 235, one or more physical design files may be provided which specify the design after it has been synthesized (e.g., converted and optimized), mapped, placed, and routed for PLD 100 (e.g., by combining the results of the corresponding previous operations). In operation 240, system 130 generates configuration data for the synthesized, mapped, placed, and routed design.

In operation 245, the configuration data is stored for subsequent use by PLD 100. For example, in some embodiments, the configuration data is stored in a non-volatile memory (e.g., within PLD 100 itself or external to PLD 100 such as in machine-readable medium 136). When PLD 100 is started (e.g., powered on), the configuration data is loaded from the non-volatile memory into appropriate volatile memory of PLD 100 to configure PLD 100 for use. In other embodiments, the configuration data is stored by external system 130 and/or machine-readable medium 136 and loaded into appropriate volatile memory of PLD 100 when PLD is started. In operation 250, the design as implemented by the configuration data is tested as further described herein.

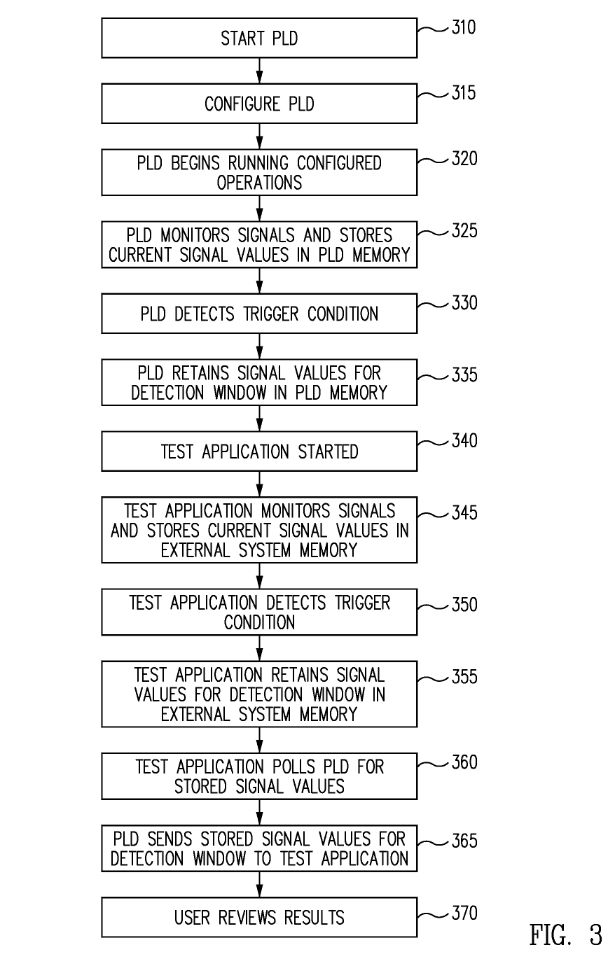

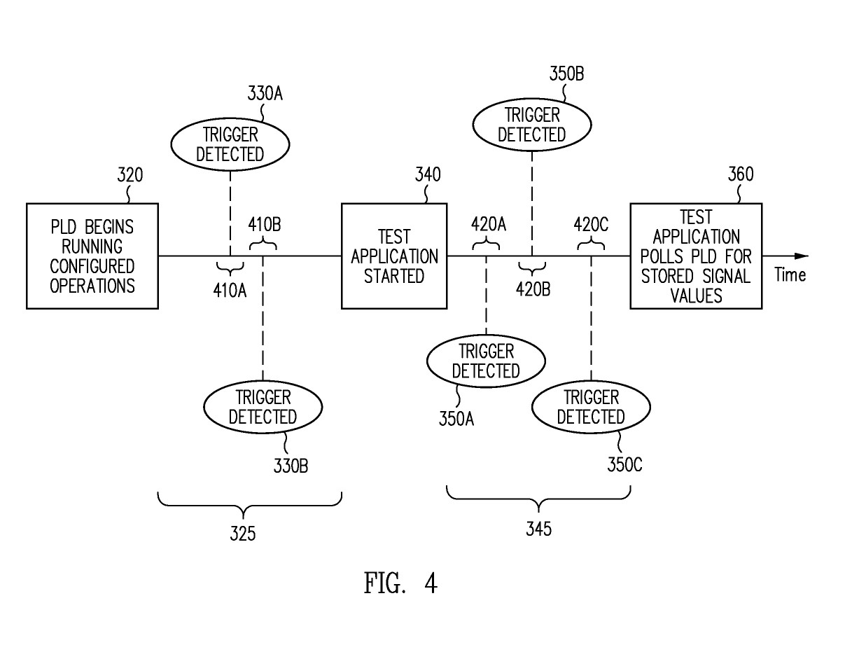

FIG. 3 illustrates a test process for a PLD in accordance with an embodiment of the disclosure. In some embodiments, the process of FIG. 3 may be performed in operation 250 of FIG. 2. FIG. 4 illustrates a timeline corresponding to various operations of FIG. 3 in accordance with an embodiment of the disclosure.

In operation 310, PLD 100 is started. In some embodiments, this includes performing a power on reset (POR) operation in response to an external signal (e.g., received from system 130), a powering on of PLD 100, or other appropriate manner.

In operation 315, PLD 100 is configured with the configuration data previously stored in operation 245. In some embodiments, this includes loading the configuration data into appropriate volatile memory of PLD 100 to configure PLD 100 for use as discussed.

As also discussed, the configuration data configures PLD 100 to implement the user design (e.g., received in operation 210) and also to monitor one or more signals (e.g., corresponding to trigger information received in operation 215) and store associated data within memory 106 of PLD 100. In this regard, the configuration data configures PLD 100 to operate in accordance with the user design, and further to monitor signals and store logged data associated with the signals.

In operation 320, after the configuration data has been loaded, PLD 100 begins running the various configured operations. As part of its post-configuration operation, PLD 100 may initiate one or more signal transitions on a first external pin provided by I/O blocks 102. The first external pin may be connected to a second external pin provided by I/O blocks 102, thus permitting PLD 100 to detect that the configuration is complete (e.g., through configured logic blocks 104 in communication with the second external pin).

In operation 325, configured logic blocks 104 of PLD 100 monitor the various PLD signals associated with the previously identified trigger conditions and stores the values of the monitored signals in memory 106 of PLD 100. For example, for a particular monitored signal, PLD 100 may store one or more samples (e.g., snapshots) of the monitored signals. In this regard, PLD 100 may store the current value of a monitored signal at various intervals (e.g., every clock cycle or at intervals of multiple clock cycles) and retain the most recent values occurring over a detection window period (e.g., corresponding to 100 clock cycles in one embodiment).

Accordingly, in such an embodiment, if a monitored signal value is stored for each clock cycle over a detection window of 100 clock cycles, then PLD 100 will store and repeatedly update the most recent 100 values of the monitored signal corresponding to the preceding 100 clock cycles.

In operation 330, PLD 100 detects that a trigger condition for a monitored signal has been satisfied. For example, in the case of a signal associated with a counter value, PLD 100 may detect that the counter has reached a particular predetermined value. As another example, in the case of a signal associated with a state machine, PLD 100 may detect that the state machine has transitioned to a particular state. Other types of signals are also contemplated.

PLD 100 may store samples of the monitored signal values prior to the occurrence of the trigger condition. As a result, at the time the trigger condition occurs, PLD 100 will have already stored preceding values of the monitored signal. In some embodiments, PLD 100 may continue monitoring and storing values of the tracked signals for at least a time period following the occurrence of the trigger condition.

In operation 335, PLD 100 stops monitoring the signal that has satisfied the trigger condition and retains in memory the stored values of the monitored signal that occurred prior to and after the occurrence of the trigger condition. Thus, following operation 335, PLD 100 will have stored values of the monitored signal over a time period (e.g., a detection window) that extends before and after the occurrence of the trigger condition.

Operations 325, 330, and 335 may be repeated for multiple monitored signals. In this regard, different signals may exhibit trigger conditions at different points in time. These operations can be further understood with reference to FIG. 4.

Referring now to FIG. 4, operation 320 is represented on the leftmost portion of the illustrated timeline. As discussed, at operation 320, PLD 100 has been configured and begins operating in accordance with the configured design and specified triggers.

Operation 325 is represented by the time period between operations 320 and 340. As discussed, during this time, PLD 100 monitors signals and stores signal values. Two occurrences of operation 330 (labeled 330A and 330B) are represented which correspond to the detection of trigger conditions for two signals at different times during monitoring operation 325.

As discussed with regard to operation 335, PLD 100 retains in memory the values of monitored signals that occur during detection windows that extend prior to and after the occurrence of the trigger conditions. FIG. 4 illustrates two example detection windows 410A and 410B corresponding to trigger detections 330A and 330B, respectively.

Referring again to FIG. 3, in operation 340, test application 192 starts running on external system 130. Operation 340 may be performed, for example, by a user interacting with external system 130, external system 130 responding to a signal provided by PLD 100, or another appropriate manner.

In operation 345, test application 192 of external system 130 monitors additional PLD signals associated with the test application triggers previously discussed with regard to operation 215. Similar to the triggers monitored by PLD 100, test application 192 may store values of monitored signals (e.g., in memory 134 of external system 130) at various intervals and retain the most recent values occurring over corresponding detection window periods.

In operation 350, test application 192 detects that a trigger condition for a monitored signal has been satisfied. Similar to PLD 100, test application 192 may store multiple samples of the monitored signal values prior to the occurrence of the trigger condition and may continue monitoring and storing values of the tracked signals for at least a short time period following the occurrence of the trigger condition.

In operation 355, test application 192 stops monitoring the signal that has satisfied the trigger condition and retains in memory the values of the monitored signal that occurred prior to and after the occurrence of the trigger condition. Thus, following operation 355, test application 192 will have stored values of the monitored signal over a time period (e.g., a detection window) that extends before and after the trigger condition.

Operations 345, 350, and 355 may be repeated for multiple monitored signals. In this regard, different signals may exhibit trigger conditions at different points in time.

Referring again to FIG. 4, operation 340 is represented in the center portion of the illustrated timeline. As discussed, at operation 340, test application 192 starts running on external system 130.

Operation 345 is represented by the time period between operation 340 and the rightmost portion of the illustrated timeline. As discussed, during this time, test application 192 monitors signals and stores signal values. Three occurrences of operation 350 (labeled 350A, 350B, and 350C) are represented which correspond to the detection of trigger conditions for three signals at different times. FIG. 4 also illustrates three example detection windows 420A, 420B, and 420C corresponding to trigger detections 330A, 330B, and 330C, respectively.

Referring again to FIG. 3, in operation 360, test application 192 completes its monitoring of signal values and polls PLD 100 for any stored signal values. If PLD 100 has detected any trigger conditions, then PLD 100 passes (e.g., through a JTAG port) the stored signal values (e.g., corresponding to the values of monitored signals occurring during detection windows 410A and 410B) to external system 130 and received by test application 192 in operation 365.

In operation 370, test application displays the stored signal values resulting from PLD-based and external system-based trigger conditions for review by the user. The stored signal values identify signal values occurring in detection windows 410A and 410B that fall in the period elapsing between operation 320 (e.g., when PLD 100 begins operating in accordance with its configured logic) and operation 340 (e.g., when test application 192 is started). The stored signal values also identify signal values occurring in detection windows 420A, 420B, and 420C that fall in the period elapsing between operation 340 and operation 360 (e.g., when test application 192 polls PLD 100 for any stored signal values). Thus, these various stored signal values permit a user to have a more complete understanding of the operation of PLD 100, even before test application 192 has been started.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A machine-implemented method comprising:
monitoring, by a programmable logic device (PLD), a signal of the PLD;
detecting a trigger condition associated with the signal;
storing data in memory of the PLD corresponding to values of the signal; and
passing the stored data from the PLD to an external device running a test application, wherein the stored data comprises values of the signal occurring before the running of the test application.

2. The machine-implemented method of claim 1, wherein the storing comprises:
storing a first portion of the data corresponding to values of the signal occurring before the trigger condition is detected; and
storing a second portion of the data corresponding to values of the signal occurring after the trigger condition is detected.

3. The machine-implemented method of claim 1, wherein:
the data comprises values of the signal occurring during a detection window; and
the detection window spans from a first time before the trigger condition is detected to a second time after the trigger condition is detected.

4. The machine-implemented method of claim 1, wherein the signal identifies a state of a state machine operated by the PLD.

5. The machine-implemented method of claim 1, wherein the signal identifies a value of a counter operated by the PLD.

6. The machine-implemented method of claim 1, further comprising:
receiving a user design;
receiving trigger information identifying the trigger condition; and
generating configuration data to configure the PLD to detect the trigger condition and store the data.

7. The machine-implemented method of claim 1, wherein the signal is a first signal and the trigger condition is a first trigger condition, the method further comprising:
passing a second signal of the PLD to the external device;
monitoring, by the test application, the second signal;
detecting a second trigger condition associated with the second signal; and
storing data at the external device corresponding to values of the second signal.

8. The machine-implemented method of claim 7, further comprising presenting to a user of the external device to evaluate operation of the PLD:
at least one of the stored data values associated with the first signal; and
at least one of the stored data values associated with the second signal.

9. A non-transitory machine-readable medium storing a plurality of machine-readable instructions executable by the PLD to cause the PLD to perform the method of claim 1.

10. A system comprising:
a programmable logic device (PLD) comprising a plurality of logic blocks configured to:
monitor a signal of the PLD;
detect a trigger condition associated with the signal;
store data in memory of the PLD corresponding to values of the signal; and
pass the stored data from the PLD to an external device running a test application, wherein the stored data comprises values of the signal occurring before the running of the test application.

11. The system of claim 10, wherein the data comprises:
a first portion of the data corresponding to values of the signal occurring before the trigger condition is detected; and
a second portion of the data corresponding to values of the signal occurring after the trigger condition is detected.

12. The system of claim 10, wherein:
the data comprises values of the signal occurring during a detection window; and
the detection window spans from a first time before the trigger condition is detected to a second time after the trigger condition is detected.

13. The system of claim 10, wherein the signal identifies a state of a state machine operated by the PLD.

14. The system of claim 10, wherein the signal identifies a value of a counter operated by the PLD.

15. The system of claim 10, further comprising the external device comprising:
a processor; and
a memory adapted to store a plurality of machine-readable instructions which when executed by the processor are adapted to cause the external device to:
receive a user design,
receive trigger information identifying the trigger condition, and
generate configuration data to configure the PLD to perform the monitor, detect, store, and pass operations.

16. The system of claim 10, wherein the signal is a first signal and the trigger condition is a first trigger condition, the system further comprising the external device comprising:
a processor; and
a memory adapted to store a plurality of machine-readable instructions which when executed by the processor are adapted to cause the external device to run the test application to:
monitor a second signal of the PLD,
detect a second trigger condition associated with the second signal, and
store data at the external device corresponding to values of the second signal.

17. The system of claim 16, wherein the test application is adapted to cause the external device to present to a user of the external device to evaluate the operation of the PLD:
at least one of the stored data values associated with the first signal; and
at least one of the stored data values associated with the second signal.

18. A non-transitory machine-readable medium storing a plurality of machine-readable instructions which when executed by a computer system are adapted to cause the computer system to perform a method comprising:
receiving a user design;
receiving trigger information identifying a trigger condition associated with a signal of a programmable logic device (PLD);
generating configuration data to configure the PLD to detect the trigger condition and store data in memory of the PLD corresponding to values of the signal; and
running a test application, wherein the stored data comprises values of the signal occurring before the running of the test application.

19. The machine-readable medium of claim 18, wherein the signal is a first signal and the trigger condition is a first trigger condition, wherein the method further comprises:
receiving a second signal of the PLD;
monitoring, by the test application, the second signal;
detecting a second trigger condition associated with the second signal; and
storing data corresponding to values of the second signal.

20. The machine-readable medium of claim 19, wherein the method further comprises presenting to a user of the external device to evaluate operation of the PLD:
at least one of the stored data values associated with the first signal; and
at least one of the stored data values associated with the second signal.
